(19) United States
(12) Patent Application Publication
(10) Pub. No.: US 2025/0026938 A1
(43) Pub. Date: Jan. 23, 2025

(54) Fluorine-free Water- and oil-resistant Coating Composition and Coating Solution, Coating Layer, and Product Comprising the Same

(71) Applicant: Nano and Advanced Materials Institute Limited, Hong Kong (HK)

(72) Inventors: Yan Yan LAM, Hong Kong (HK); Kwan Shing CHAN, Hong Kong (HK); Chi Ho WONG, Hong Kong (HK); Chui Wan TSE, Hong Kong (HK); Yong ZHU, Hong Kong (HK)

(21) Appl. No.: 18/762,661

(22) Filed: Jul. 3, 2024

Related U.S. Application Data
(60) Provisional application No. 63/514,781, filed on Jul. 20, 2023.

(51) Int. Cl. C09D 5/16; C08K 3/34; C09D 123/08; C09D 129/06; D21H 19/40; D21H 19/60; D21H 21/16

(52) U.S. Cl. CPC C09D 5/1687; C09D 5/1668; C09D 123/0846; C09D 129/06; D21H 19/40; D21H 19/60; D21H 21/16; C08K 3/346; C08K 2201/005

(57) ABSTRACT

The present invention provides a fluorine-free water- and oil-resistant coating composition comprising 30 wt % to 97 wt % biodegradable polymer in dry weight, less than 25 wt % crosslinking agent in dry weight, less than 25 wt % nanoparticles, less than 15 wt % plasticizer, less than 15 wt % surfactant and less than 1 wt % antifoaming agent in dry weight. The fluorine-free water- and oil-resistant coating composition relates to green chemistry and demonstrates both water resistance and grease resistance.

### CROSS-REFERENCE TO RELATED APPLICATION

The present application claims priority from U.S. provisional patent application Ser. No. 63/514,781 filed Jul. 20, 2023, and the disclosures of which are incorporated by reference in their entireties.

### FIELD OF THE INVENTION

The present invention relates to a water- and oil-resistant coating composition and, more particularly, to a fluorine-free water- and oil-resistant coating composition.

### BACKGROUND

The use of paper based food packaging is increasing as single-use plastic materials are in the process of being banned in various jurisdictions. Although paper is both biodegradable and recyclable, paper is not water- and oil-resistant. Wax, perfluroalkyl, and polyfluoroalkyl substances (PFAS) can be mixed with paper pulp or coated on paper to make the paper water- and oil-resistant. Furthermore, these water- and oil-resistant paper products are used for paper wrappers, paper bags, paper bowls and cardboard. However, wax is not stable at high temperature and fluorine-containing substances are difficult to decompose.

Various techniques have been proposed for providing water- and oil-resistant coatings for paper products. U.S. Pat. No. 8,992,733 B2 “Water and oil resistant agent for paper and paper treatment process” discloses a water- and oil-resistant agent for paper comprising a fluorine-containing copolymer obtained by copolymerizing a (meth)acrylate monomer having a polyfluoroalkyl group having 1 to 6 carbon atoms.

China patent CN 106592333B “Preparation method of hydrophobic and oleophobic paper packaging material” discloses a preparation method of a water- and oil-resistant paper packaging material comprising the steps as follows: preparing fluorine-modified acrylate resin; adding hydrophobic alumina particles to the fluorine-modified acrylate resin for modification to render a water- and oil-resistant agent; applying the water- and oil-resistant agent to the surface of paper packaging material.

When paper coated with fluorine-containing copolymer or resin is disposed after use, the fluorine-containing copolymer or resin cannot be decomposed biologically and may be persistent in the environment or even in human body. An increasing number of scientific reports show that PFAS and fluorinated compounds are bioaccumulative, non-biodegradable, persistent in the environment, and toxic to animals' liver, kidney and immune system. Recently, Grandjean et al. reported that increased plasma-PFBA concentrations are associated with a greater severity of COVID-19 prognosis, and this tendency remains after adjustment for sex, age, comorbidities, national origin, sampling location and time.

Therefore, there is a need for fluorine-free water- and oil-resistant coating composition on paper packaging for use as an alternative for fluorinated paper packaging to reduce the accumulation of toxic fluorinated chemicals in the environment and potential hazards on ecosystem and human. The present invention addresses this need.

### SUMMARY OF THE INVENTION

The present invention provides a fluorine-free water- and oil-resistant coating composition comprising (dry weight prior to mixing with a solvent) 30 wt % to 97 wt % of biodegradable polymer; 0.1 wt % to 25 wt % of crosslinking agent; 25 wt % or less of nanoparticles; 15 wt % or less of plasticizer; 15 wt % or less of surfactant; and 1 wt % of less of antifoaming agent.

The fluorine-free water- and oil-resistant coating composition of the present invention provides both water resistance and grease resistance. Because the water- and oil-resistant coating composition does not include any fluorine-containing substances, the coating is eco-friendly and thus increases the value of paper products employing the coating.

In the specification, the molecular weight refers to weight-average molecular weight.

In another aspect, the biodegradable polymer is selected from chitosan with molecular weight from 20,000 to 2,000,000, polyvinyl alcohol with molecular weight from 50,000 to 186,000 and a degree of hydrolysis from 90% to 99%, ethylene-vinyl alcohol copolymer (EVOH) with an ethylene content of less than 10 mol %, a viscosity of 3-35 m·Pas (4 wt % aqueous solution at 20° C.) and a degree of hydrolysis of 90.0-99.5%, polyhydroxyalkanoates (PHA) such as polyhydroxybutyrate (PHB), polyhydroxyvalerate (PHV) and polyhydroxybutyrate-hydroxyvalerate copolymer (PHBV) with molecular weight from 500 to 1,000,000 or the combination thereof. Specific exemplary EVOH suitable for use described herein include Exceval commercially available from Kuraray Co., Ltd. PHA are commercially available from various suppliers for example, Biomer (Germany), Ecomann Technology Co., Ltd. (China), Kanegafuchi Chemical Industry Co. Ltd. (Japan), Tianjin Green Bioscience (China), Tianan Biological Material Co. (China).

In another aspect, the crosslinking agent is selected from citric acid, malic acid, succinic acid, tannic acid, tartaric acid, sodium trimetaphosphate, sodium hexametaphosphate, sodium sulfate or combinations thereof.

In another aspect, the nanoparticle is selected from silicon dioxide, zinc oxide, nano clay or combinations thereof, and the nanoparticle has a particle diameter of 2 nm to 500 nm. The addition of nanoparticle can increase the surface roughness of the coating composition to create an air cushion on the surface which provides better water resistance.

In another aspect, the plasticizer is selected from glycerol, sorbitol, mannitol, xylitol, polyethylene glycol, tributyl citrate or the combination thereof. The addition of plasticizer can increase the flexibility of the coating composition. Depending on the selection of various plasticizers, the viscosity of the coating composition can be reduced or increased. Higher or lower viscosities may be selected based on the chosen coating technique.

In another aspect, the surfactant is selected from a polyoxyethylene sorbitan monolaurate-based surfactant (e.g., Tween 20), a polyoxyethylene sorbitan monopalmitate-based surfactant (e.g., Tween 40), a polyoxyethylene sorbitan monooleate-based surfactant (e.g., Tween 80) or combinations thereof. The addition of surfactant can promote the miscibility when mixed with solvent to render the fluorine-free coating solution.

In another aspect, the antifoaming agent is selected from conventional silicone-based, water-based and oil-based antifoaming agents such as hydrophobic silica, fatty alcohol, mineral oil or combinations thereof. The addition of antifoaming agent can minimize foam formation in the coating solution.

The present invention also provides a fluorine-free coating solution comprising the fluorine-free water- and oil-resistant coating composition and a solvent, and the weight ratio of the fluorine-free water- and oil-resistant coating composition to the solvent is 1:1 to 1:20.

In another aspect, the solvent is selected from distilled water, deionized water, methanol, ethanol, propanol, acetic acid, acetone, chloroform, dichloromethane, butyl acetate, ethyl acetate, methyl ethyl ketone, dimethyl carbonate, dimethyl formamide, dimethyl sulfoxide or combinations thereof.

The present invention also provides a fluorine-free coating layer comprising the fluorine-free coating composition.

In another aspect, the fluorine-free coating layer is cured by heat treatment of 80° C. to 180° C.

In another aspect, the fluorine-free coating layer has a water resistant property as demonstrated by the Cobb method at a Cobb60 value of less than 10 g/m² according to the ISO 535 method and a grease resistant property as demonstrated by a kit rating at least 7 according to the TAPPI T-559 method.

The present invention also provides a fluorine-free product comprising the fluorine-free coating layer on a substrate.

In another aspect, the substrate is paper, paper container, cardboard or cellulose film.

In other aspect, the fluorine-free coating layer can be applied on the substrate by brush coating, dip coating, bar coating or blade coating.

### BRIEF DESCRIPTION OF DRAWINGS

Embodiments of the invention are described in more details hereinafter with reference to the drawings, in which:

FIG. 1 illustrates a water droplet kept for 1 minute and then removed with water absorption observed on the paper without fluorine free coating layer (top) and a water droplet kept for 1 minute and then removed without water absorption observed on the paper coated with the fluorine free coating layer of the present invention (bottom).

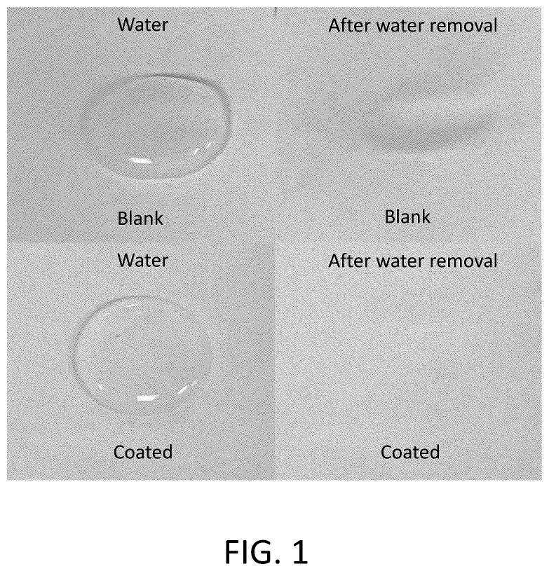

FIG. 2 illustrates a castor oil droplet and a peanut oil droplet kept for 10 minutes absorbed by the paper without fluorine free coating layer (left) and a castor oil droplet and a peanut oil droplet kept for 10 minutes on the paper coated with the fluorine free coating layer of the present invention (right).

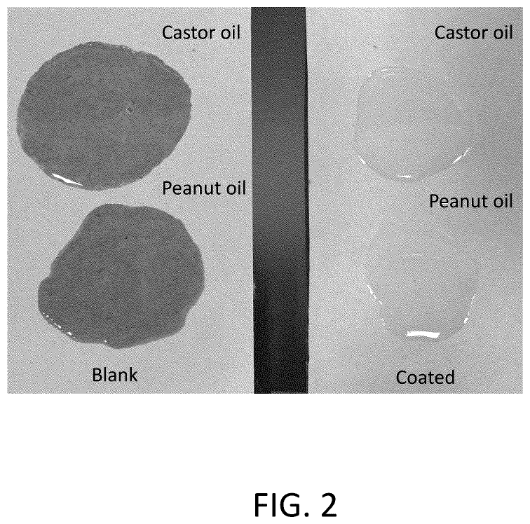

### DETAILED DESCRIPTION

The present invention relates to a fluorine-free water- and oil-resistant coating composition to be applied on paper or cellulose based packaging.

While water- and oil-resistance coating is on an increasing demand coupled with the increasing use of paper-based food packaging, fluorinated compounds (in particular polyfluoroalkyl substances (PFAS)) remains to be the most popular choice for omnophobic coating of paper products.

However, fluorinated compounds, PFAS included, have been linked to health issues due to its intrinsic toxicity and bioaccumulation, which could be associated with multiple adverse effects and health risks, including but not limited to cancers, hepatic damage, thyroid diseases and immune system problems.

In addition, fluorinated compounds are known to be extremely difficult to decompose naturally, therefore fluorinated paper waste products may be a long-term biotoxic pollution source.

Therefore, the fluorine-free water- and oil-resistant coating composition in the present invention includes biodegradable polymer, crosslinking agent, nanoparticles, plasticizer and surfactant; the composition is mixed with a solvent to render a fluorine-free coating solution. The coating solution is formulated to be strictly fluorine-free, offering a regulatory-compliant, environmentally friendly and non-toxic alternative to PFAS.

The fluorine-free water- and oil-resistant coating composition can be applied on the substrate by bar coating, blade coating, brush coating, dip coating, roll coating, slot-die coating, spin coating or spray coating, enabling versatile and simple application to paper products.

Particularly, the fluorine-free water- and oil-resistant coating composition includes 30 wt % to 97 wt % biodegradable polymer in dry weight, 0.1 wt % to 25 wt % crosslinking agent in dry weight, 0 wt % to 25 wt % nanoparticles, 0 wt % to 15 wt % plasticizer, 0 wt % to 15 wt % surfactant and 0 wt % to 1 wt % antifoaming agent in dry weight.

The water resistance property of the fluorine-free coating layer is represented by its water absorptiveness according to the ISO 535 method.

The ISO 535 method specifies the determination of the quantity of water that can be absorbed by the surface of paper or board in a given time. The water absorptiveness (Cobb value) is the calculated mass of water absorbed in a specified time by 1 m² of paper or board under specified conditions. For determination of a Cobb60 value, the paper coated with the fluorine-free coating layer of a test area of 100 cm² is weighed immediately before and immediately after exposure for 60 seconds of one surface to 100 mL of water, followed by blotting. The result of the increase in mass is expressed in grams per square metre (g/m²).

The oil resistance property of the fluorine-free coating layer is represented by its grease resistance according to the TAPPI T-599 method.

In TAPPI T-599 method, the test solution compositions are shown in Table 1. A drop of test solution is placed on the paper coated with the fluorine-free coating layer. After 15 seconds, the excess test solution is removed with a clean tissue and then the condition of the coated paper is observed. A failure is denoted in the condition of test specimen with dark area (even a small area) caused by test solution. The grease resistance of the paper is assigned by the maximum kit number of test solution that no existence of dark area is observed on the coated paper.

TABLE 1
compositions of test solutions

| Kit No. | Castor oil (g) | Toluene (mL) | n-Heptane (mL) |
|---|---|---|---|
| 1 | 969 | 0 | 0 |
| 2 | 872.1 | 50 | 50 |
| 3 | 775.2 | 100 | 100 |
| 4 | 678.3 | 150 | 150 |
| 5 | 581.4 | 200 | 200 |
| 6 | 484.5 | 250 | 250 |
| 7 | 387.6 | 300 | 300 |
| 8 | 290.7 | 350 | 350 |
| 9 | 193.8 | 400 | 400 |
| 10 | 96.9 | 450 | 450 |
| 11 | 0 | 500 | 500 |
| 12 | 0 | 450 | 550 |

The biodegradable polymer may be, but is not limited to, chitosan, ethylene-vinyl alcohol copolymer (EVOH), polyvinyl alcohol (PVA) and polyhydroxyalkanoates (PHA) or the combination thereof. Preferably, chitosan with molecular weight from 20,000 to 2,000,000, PVA with molecular weight from 50,000 to 186,000 and a degree of hydrolysis from 90% to 99%, EVOH with an ethylene content of less than 10 mol %, a viscosity of 3-35 m·Pas (4 wt % aqueous solution at 20° C.) and a degree of hydrolysis of 90.0-99.5%, PHA such as polyhydroxybutyrate (PHB), polyhydroxyvalerate (PHV) and polyhydroxybutyrate-hydroxyvalerate copolymer (PHBV) with molecular weight from 500 to 1,000,000 or the combination thereof. Specific exemplary EVOH suitable for use described herein include Exceval commercially available from Kuraray Co., Ltd. PHA are commercially available from various suppliers for example, Biomer (Germany), Ecomann Technology Co., Ltd. (China), Kanegafuchi Chemical Industry Co. Ltd. (Japan), Tianjin Green Bioscience (China), Tianan Biological Material Co. (China).

Preferably, the biodegradable polymer may be 30 wt % to 97 wt % in the fluorine-free water- and oil-resistant coating composition.

The crosslinking agent may be, but is not limited to, citric acid, malic acid, succinic acid, tannic acid, tartaric acid, sodium trimetaphosphate, sodium hexametaphosphate, sodium sulfate or combinations thereof.

Preferably, the crosslinking agent may be 0.1 wt % to 25 wt % in the fluorine-free water- and oil-resistant coating composition. The coating composition with preferable range of crosslinking agent can build a network structure with high rigidity, strengthening the layer that is formed on a substrate. Particularly, both water and oil resistance could be enhanced.

The addition of nanoparticles can create a physical barrier on the surface of the coated paper, which contributes to its enhanced water resistance through increasing the surface roughness of the coating composition to create an air cushion on the surface. Particularly, the nanoparticle may be, but is not limited to, silicon dioxide, zinc oxide, nano clay or combinations thereof, and the nanoparticle has a particle diameter of 2 nm to 500 nm. Specifically, the nano clay may be, but is not limited to, halloysite, montmorillonite, kaolinite or allophane. Preferably, the particle diameter may be 30 nm to 100 nm.

Preferably, the nanoparticles may be 0 wt % to 25 wt % in the fluorine-free water- and oil-resistant coating composition.

The plasticizer is added to allow fine adjustment to achieve optimum viscosity of the coating material according to a chosen method of coating. Particularly, the plasticizer may be, but is not limited to, glycerol, sorbitol, mannitol, xylitol, polyethylene glycol, tributyl citrate or the combination thereof.

Preferably, the plasticizer may be 0 wt % to 15 wt % in the fluorine-free water- and oil-resistant coating composition.

The surfactant is added to promote miscibility when the organic components of the coating material is mixed with the solvent. The surfactant may be, but is not limited to, polyoxyethylene sorbitan monolaurate (Tween 20), polyoxyethylene sorbitan monopalmitate (Tween 40), polyoxyethylene sorbitan monooleate (Tween 80) or combinations thereof.

Preferably, the surfactant may be 0 wt % to 15 wt % in the fluorine-free water- and oil-resistant coating composition.

The antifoaming agent is added to prevent foam formation in coating solution. The antifoaming agent may be but is not limited to silicone-based, water-based and oil-based antifoam or combinations thereof.

The fluorine-free water- and oil-resistant coating composition is mixed with a solvent to render a fluorine-free coating solution with a desired viscosity to facilitate application to the paper packaging. The weight ratio of the fluorine-free water- and oil-resistant coating composition to the solvent is 1:1 to 1:20, 1:1 to 1:15 or 1:1 to 1:10.

The solvent may be, but is not limited to, distilled water, deionized water, methanol, ethanol, propanol, acetic acid, acetone, chloroform, dichloromethane, butyl acetate, ethyl acetate, methyl ethyl ketone, dimethyl carbonate, dimethyl formamide, dimethyl sulfoxide, ethylene carbonate or combinations thereof.

In one of the embodiments, the solvent is a dual solvent system.

Preferably, the fluorine-free coating solution may be a homogeneous solution.

The fluorine-free coating layer may be cured at an elevated temperature. Curing may be performed, for example using an oven or a microwave chamber. Preferably, the fluorine-free coating layer is cured by heat treatment of 80° C. to 180° C. During curing, crosslinking of the coating solution may occur.

In one of the embodiments, the fluorine-free coating layer has a water resistant property as demonstrated by Cobb60 value of less than 1 g/m² according to ISO 535 method and grease resistant property as demonstrated by a kit rating of 12 according to the TAPPI T-559 method.

The fluorine-free product may be, but is not limited to, a paper wrapper, a paper bag, a paper bowl, a paper cup or a paper cardboard.

### EXAMPLE

### Preparation, Water-Resistance and Oil-Resistance Testing of Example 1

16 parts by weight of ethylene-vinyl alcohol copolymer (EVOH) (viscosity of 3-35 m·Pas (4 wt % aqueous solution at 20° C.) and a degree of hydrolysis of 90.0-99.5%) was mixed with 81.6 parts by weight of water and heated for 1 hour at 95° C. 1.6 part by weight of nanoclay (particle diameter: 2 to 100 nm) and 0.8 parts by weight of citric acid was mixed with EVOH. The final mixture was further stirred for 2 hours under 95° C. water bath and the fluorine-free coating solution of Example 1 was formed. The fluorine-free water- and oil-resistant coating composition of Example 1 was applied on paper packaging by bar coating and cured at 120 to 180° C. to render fluorine-free coating layer of Example 1A.

The fluorine-free coating layer of Example 1A is subjected to a water absorptiveness test for 60 s time of test under the International Standard ISO 535. The test result shows a Cobb60 water absorbency value of lower than 1 g/m², suggesting considerable water resistance.

The fluorine-free coating layer of Example 1A is also subjected to a grease resistance test according to standard method of TAPPI T-559. The fluorine-free coating layer of Example 1A achieves a kit rating of 12 in the test, meaning that the fluorine-free coating layer is able to sustain the highest numbered oil/grease solution (the most aggressive) remaining on its surface without causing failure, exhibiting high oil resistance.

### Preparation of Example 2

1 part by weight of nanoclay (particle diameter: 5 to 100 nm) dispersed in 45 parts by weight of water and homogenized for 2 minutes by using an ultrasound sonicator. The nanoclay dispersion was added to 16 parts by weight of ethylene-vinyl alcohol copolymer (EVOH) (viscosity of 3-35 m·Pas (4 wt % aqueous solution at 20° C.) and a degree of hydrolysis of 90.0-99.5%). 0.8 parts by weight of chitosan (Mw: 50,000-190,000, deacetylated degree: 75-85%) and 0.8 parts by weight of citric acid was mixed with 36.4 parts by weight of water and then added to the EVOH-nanoclay mixture. Afterwards, the final mixture was further stirred for 2 hours under 95° C. water bath and the fluorine-free coating solution of Example 2 was formed. The fluorine-free water- and oil-resistant coating composition of Example 2 was applied on paper packaging by bar coating and cured at 120 to 180° C. to render fluorine-free coating layer of Example 2A.

The fluorine-free coating layer of Example 2A is subjected to a water absorptiveness test for 60 s time of test under the International Standard ISO 535. The test result shows a Cobb60 water absorbency value of lower than 1 g/m², suggesting considerable water resistance.

The fluorine-free coating layer of Example 2A is also subjected to a grease resistance test according to standard method of TAPPI T-559. The fluorine-free coating layer of Example 2A also achieves a kit rating of 12 in the test, showing high oil resistance.

As used herein, terms “approximately”, “basically”, “substantially”, and “about” are used for describing and explaining a small variation. When being used in combination with an event or circumstance, the term may refer to a case in which the event or circumstance occurs precisely, and a case in which the event or circumstance occurs approximately. As used herein with respect to a given value or range, the term “about” generally means in the range of ±10%, ±5%, ±1%, or ±0.5% of the given value or range. The range may be indicated herein as from one endpoint to another endpoint or between two endpoints. Unless otherwise specified, all the ranges disclosed in the present disclosure include endpoints. The term “substantially coplanar” may refer to two surfaces within a few micrometers (μm) positioned along the same plane, for example, within 10 μm, within 5 μm, within 1 μm, or within 0.5 μm located along the same plane. When reference is made to “substantially” the same numerical value or characteristic, the term may refer to a value within ±10%, ±5%, ±1%, or ±0.5% of the average of the values.

Several embodiments of the present disclosure and features of details are briefly described above. The embodiments described in the present disclosure may be easily used as a basis for designing or modifying other processes and structures for realizing the same or similar objectives and/or obtaining the same or similar advantages introduced in the embodiments of the present disclosure. Such equivalent construction does not depart from the spirit and scope of the present disclosure, and various variations, replacements, and modifications can be made without departing from the spirit and scope of the present disclosure.

1. A fluorine-free water- and oil-resistant coating composition comprising:
30 wt % to 97 wt % biodegradable polymer in dry weight;
0.1 wt % to 25 wt % crosslinking agent in dry weight;
25 wt % or less of nanoparticles;
15 wt % or less of plasticizer; and
15 wt % or less of surfactant;
1 wt % or less of antifoaming agent in dry weight,
wherein a coating layer comprising the fluorine-free coating composition has a water resistant property of a Cobb60 value of less than 10 g/m according to the ISO 535 method and a grease resistant property of a kit rating at least 7 according to the TAPPI T-559 method.

2. The fluorine-free water- and oil-resistant coating composition of claim 1, wherein the biodegradable polymer is selected from:
chitosan with molecular weight from 20,000 to 2,000,000;
polyvinyl alcohol with molecular weight from 50,000 to 186,000 and a degree of hydrolysis from 90% to 99%;
ethylene-vinyl alcohol copolymer (EVOH) with an ethylene content of less than 10 mol %, a viscosity of 3-35 m·Pas (4 wt % aqueous solution at 20° C.) and a degree of hydrolysis of 90.0-99.5%;
polyhydroxyalkanoates (PHA) with molecular weight from 500 to 1,000,000; or
combination thereof.

3. The fluorine-free water- and oil-resistant coating composition of claim 1, wherein the crosslinking agent is selected from citric acid, malic acid, succinic acid, tannic acid, tartaric acid, sodium trimetaphosphate, sodium hexametaphosphate, sodium sulfate or a combination thereof.

4. The fluorine-free water- and oil-resistant coating composition of claim 1, wherein the nanoparticle is selected from silicon dioxide, zinc oxide, nano clay or a combination thereof.

5. The fluorine-free water- and oil-resistant coating composition of claim 4, wherein the nanoparticle has a particle diameter of 5 nm to 100 nm.

6. The fluorine-free water- and oil-resistant coating composition of claim 1, wherein the plasticizer is selected from glycerol, sorbitol, mannitol, xylitol, polyethylene glycol, tributyl citrate or combinations thereof.

7. The fluorine-free water- and oil-resistant coating composition of claim 1, wherein the surfactant is selected from a polyoxyethylene sorbitan monolaurate-based surfactant, a polyoxyethylene sorbitan monopalmitate-based surfactant, a polyoxyethylene sorbitan monooleate-based surfactant or combinations thereof.

8. The fluorine-free water- and oil-resistant coating composition of claim 1, wherein the antifoaming agent is selected from silicone-based, water-based and oil-based antifoam or combinations thereof.

9. A fluorine-free coating solution comprising the fluorine-free water- and oil-resistant coating composition of claim 1 and a solvent, wherein the weight ratio of the fluorine-free water- and oil-resistant coating composition to the solvent is 1:1 to 1:20.

10. The fluorine-free coating solution of claim 8, wherein the solvent is selected from distilled water, deionized water, methanol, ethanol, propanol, acetic acid, acetone, chloroform, dichloromethane, butyl acetate, ethyl acetate, methyl ethyl ketone, dimethyl carbonate, dimethyl formamide, dimethyl sulfoxide or combinations thereof.

11. A fluorine-free coating layer comprising the fluorine-free coating solution of claim 8.

12. The fluorine-free coating layer of claim 10, wherein the fluorine-free coating layer is cured by heat treatment of 80° C. to 180° C.

13. A fluorine-free product comprising the fluorine-free coating layer of claim 10 on a substrate.

14. The fluorine-free product of claim 13, wherein the fluorine-free coating layer is applied on the substrate by brush coating, dip coating, bar coating or blade coating.

15. The fluorine-free product of claim 13, wherein the substrate is paper, paper pulp container, cardboard or cellulose film.
